(19) United States
(12) Patent Application Publication
(10) Pub. No.: US 2003/0193944 A1
(43) Pub. Date: Oct. 16, 2003

(54) Routing apparatus and routing method in network

(76) Inventor: Yasushi Sasagawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/369,971

(22) Filed: Feb. 19, 2003

(30) Foreign Application Priority Data
Apr. 12, 2002 (JP) 2002-110962

(51) Int. Cl. H04L 12/28; H04L 12/56

(52) U.S. Cl. 370/389; 370/428

(57) ABSTRACT

A routing apparatus in a network supporting label switching among a plurality of repeating apparatuses, comprising a path setting unit for setting paths to be label switched in the network and a part exclusion specifying unit for specifying to the path setting unit one or more parts not to be passed through among the paths to be set. By this, the degree of freedom and flexibility of the routing can be raised.

### BACKGROUND OF THE INVENTION

1. Field of the Invention

The present invention relates to a routing apparatus and a routing method in a network, more particularly relates to a constraint-based routing or explicit routing technique in an Intranet, Internet backbone, an optical network, transport network, etc. using multi protocol label switching and/or generalized multi protocol label switching (MPLS/GMPLS).

2. Description of the Related Art

“Label switching” is a basic technique for realizing true high speed data transfer, decentralization of traffic, bandwidth control, etc. for an Intranet and Internet backbone. It combines routing at an IP level (layer 3) and switching of an ATM, frame relay, Ethernet, or other lower layer (layer 2), gives a “label” to an IP packet, and performs forwarding of the layer 2 by this “label”. This label switching is presently being standardized as the MPLS in the MPLS-WG (Working Group) of the Internet Engineering Task Force (IETF). Some of the basic functions have finished being standardized.

Further, work for standardization of the GMPLS—the MPLS generalized for application to an optical network, transport network, etc. —is starting at the IETF, ITU-T, Optical Internetworking Forum (OIF), etc.

The MPLS assumes that the forwarding plane has the capability of recognizing a packet boundary or a cell boundary for forwarding data in units of packets or units of cells and the capability of processing a packet header or a cell header. In the GMPLS, however, the forwarding plane also covers apparatuses recognizing neither the packet boundary nor cell boundary.

Therefore, the GMPLS is generalized to be able to support time-division switches (for example SONET or ADMS), wavelength switches (light λ), and space switches (for example, a switch from a port or fiber on an input side to a port or fiber on an output side) so as to also cover label switching routers (LSR) unable to forward data based on information described in the packet header or the cell header.

One of the main applications of the MPLS and/or GMPLS is traffic engineering for dynamically and automatically optimizing resources in an Intranet, internet backbone, and optical network/transport network. This is called “MPLS-TE” (traffic engineering) or just simplifying “GMPLS”. In MPLS-TE or GMPLS, it is necessary to change the set route of a label switched path (LSP) according to the status of the resources in the network. For this purpose, constraint-based routing or explicit routing becomes important.

Here, the current MPLS-TE and GMPLS will be explained in detail later with reference to a path protection (restoration) service (FIG. 12) and a link protection (restoration) service (FIG. 13) as examples of the services to be realized.

Summarizing the problems to be solved by the invention, as will be explained in detail later by referring to FIG. 12, FIG. 13, and FIG. 14 to FIGS. 17(a) to 17(d), when for example setting an LSP for protection (restoration) by the conventional explicit route specifying function, it is necessary to explicitly specify the nodes to pass through both:

(i) when setting a path excluding all repeating nodes on a primary path and

(ii) when setting a path excluding only particular nodes or links on the primary path.

For this, as will be explained later, the following functions become indispensable:

1) acquisition of topology of the network;

2) acquisition of information of the LSR through which the primary LSP passes;

3) computation of the route of a secondary LSP for link protection by both the topology information of the network and the information of the repeating nodes on the primary LSP; and

4) installing a route determination policy for dealing with cases of the existence of a plurality of routes in the computation results and determination of one route using that policy.

Conventionally, routing was carried out while continuously making use of the above functions 1) to 4). Therefore, there were the problems of a loss of freedom of routing and a remarkable lack of flexibility of routing. For this reason, for example, even if a network manager tries to provide various services on the network, realization is difficult due to the lack of that freedom and flexibility.

Also, since all of the capabilities (hardware and software) sufficient for achieving the above functions 1) to 4) must be provided, there is the problem that the LSR becomes high in cost.

### SUMMARY OF THE INVENTION

An object of the present invention is to provide a routing apparatus and method able to achieve a high degree of freedom and flexibility without increasing the cost.

To attain the above object, there is provided a routing apparatus in a network for supporting label switching among a plurality of repeating apparatuses, comprised of a path setting means (11) for setting a path to be label switched in a network (20) and a part exclusion specifying means (12) for specifying to the path setting means (11) one or more parts not to be passed through in the path to be set, whereby a high degree of freedom and flexibility can be achieved.

### BRIEF DESCRIPTION OF THE DRAWINGS

The above object and features of the present invention will be more apparent from the following description of the preferred embodiments given with reference to the accompanying drawings, wherein:

FIG. 1 is a view of the basic configuration of a routing apparatus according to the present invention;

FIG. 2 is a flowchart of the basic steps of a routing method according to the present invention;

FIGS. 3(a), 3(b), and 3(c) are views of part of an example of an ER-TLV (mixed type) data format based on the present invention (part 1);

FIGS. 4(a), 4(b), 4(c), and 4(d) are views of another part of an example of an ER-TLV (mixed type) data format based on the present invention (part 2);

FIGS. 5(a), 5(b), and 5(c) are views of an example of an EX-TLV (independent type) data format based on the present invention;

FIG. 6 is a view of the concrete configuration of a repeating apparatus;

FIG. 7 is a view of part of an example of a sequence for setting path protection based on the present invention (part 1);

FIG. 8 is a view of another part of an example of a sequence for setting path protection based on the present invention (part 2);

FIG. 9 is a view of part of an example of a route selection algorithm used in the routing apparatus 10 of the present invention (part 1);

FIG. 10 is a view of another part of an example of a route selection algorithm used in the routing apparatus 10 of the present invention (part 2);

FIG. 11 is a view of another part of an example of a route selection algorithm used in the routing apparatus 10 of the present invention (part 3);

FIG. 12 is a view of an example of construction of path protection in a network;

FIG. 13 is a view of an example of construction of link protection in a network;

FIG. 14 is a view of an example of a sequence for setting path protection (FIG. 12);

FIG. 15 is a view of an example of a sequence for setting link protection (FIG. 13);

FIGS. 16(a), 16(b), and 16(c) are views of part of an ER-TLV data format (part 1); and

FIGS. 17(a), 17(b), 17(c), and 17(d) are views of another part of an ER-TLV data format (part 2).

### DESCRIPTION OF THE PREFERRED EMBODIMENTS

Preferred embodiments of the present invention will be described in detail below while referring to the attached figures.

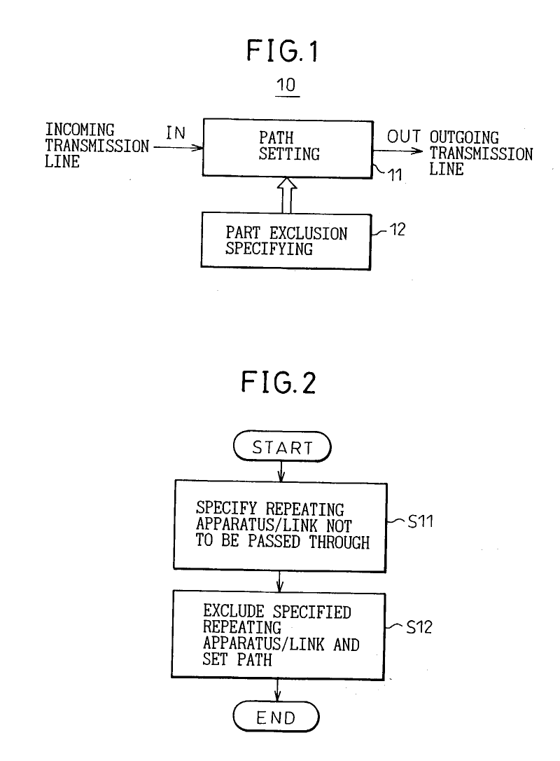

FIG. 1 is a view of the basic configuration of a routing apparatus according to the present invention.

In the figure, reference numeral 10 indicates a routing apparatus in a network supporting label switching among a plurality of repeating apparatuses. The routing apparatus 10 is provided with at least a path setting means 11 and a part exclusion specifying means 12. Here, the path setting means 11 sets the path to be label switched in the network, while the part exclusion specifying means 12 specifies to the path setting means 11 one or more parts not to be passed through in the path to be set.

Here, a “part” means at least one of a part where a repeating apparatus is located or a part in which a link spanning a plurality of repeating apparatuses is located.

Further, a “repeating apparatus” is a node or interface configuring the network.

The present invention may also be understood as a method of routing as shown below.

FIG. 2 is a flowchart of the basic steps of the routing method according to the present invention.

The method shown in the figure is a routing method for setting a path from an entrance repeating apparatus through at least one intermediate repeating apparatus to an exit repeating apparatus in a network supporting label switching among a plurality of repeating apparatuses. It is comprised of two principal steps S11 and S12.

Step S11: Specification of repeating apparatuses not to be passed through and/or links spanning two or more repeating apparatuses not to be passed through on path to be set.

Step S12: Setting of path by explicitly excluding the specified repeating apparatuses and/or links not to be passed through.

In the past, even when desiring to exclude only a certain node, interface, group of nodes, or group of interfaces, it was necessary to install the functions of the above 1) to 4) in the entrance repeating apparatus (entrance LSR or entrance server) to explicitly determine the route. According to the present invention, however, it becomes unnecessary to simultaneously install all functions, so the above problems of the related art are solved.

First, in order to facilitate understanding of the present invention, the related art will be explained in detail.

Here, the explanation will mainly be given with reference to the example of path protection (restoration) and link protection (restoration).

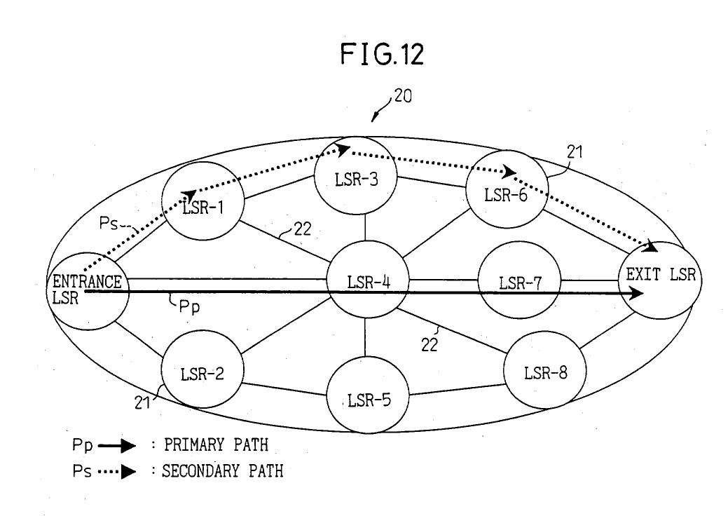

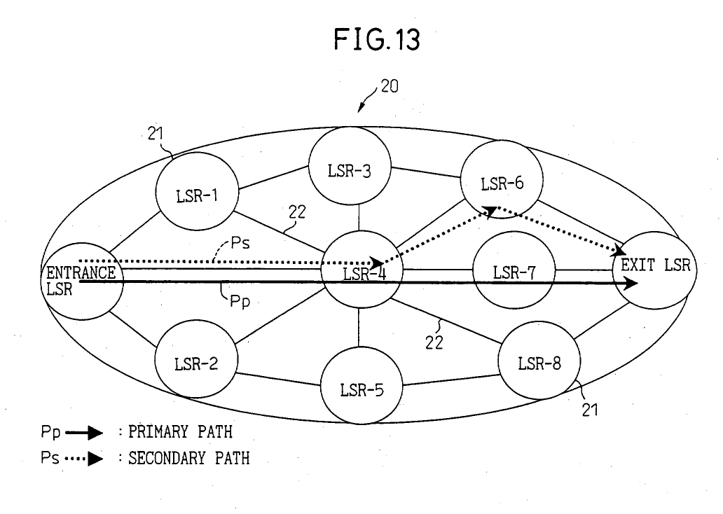

FIG. 12 is a view of an example of construction of path protection in a network, while FIG. 13 is a view of an example of construction of link protection in a network.

In these figures, reference numeral 20 indicates the network as a whole. The network 20 is comprised of a plurality of repeating apparatuses 21 and transmission lines 22 connecting them in the form of for example a mesh. Note that as the repeating apparatuses 21, LSRs are illustrated as representative examples. Also, in both figures, Pp indicates a main primary path, and Ps indicates a secondary path used for protection.

Referring to FIG. 12, assume that the LSP serving as the primary path Pp from the entrance LSR to the exit LSR is set as “entrance LSR→LSR-4→LSR-7→exit LSR”. For protection, a secondary path is set with respect to this primary path Pp.

Here, assume that there is a request from a user, provider, etc. to raise the tolerance against faults in the LSR-4 and LSR-7 and the routes connected to them. In this case, a route not passing through the LSR-4 and LSR-7, for example, a secondary path Ps constituted by the “entrance LSR→LSR-1→LSR-3→LSR-6→exit LSR”, is set.

On the other hand, referring to FIG. 13, assume that the LSP serving as the primary path Pp from the entrance LSR to the exit LSR is similarly set as the “entrance LSR→LSR-4→LSR-7→exit LSR”. The secondary path Ps for this primary Pp thereof is, in the illustrated example, set as a route not passing through only the link between the LSR-4 and LSR-7, for example, the “entrance LSR→LSR-4→LSR-6→exit LSR”.

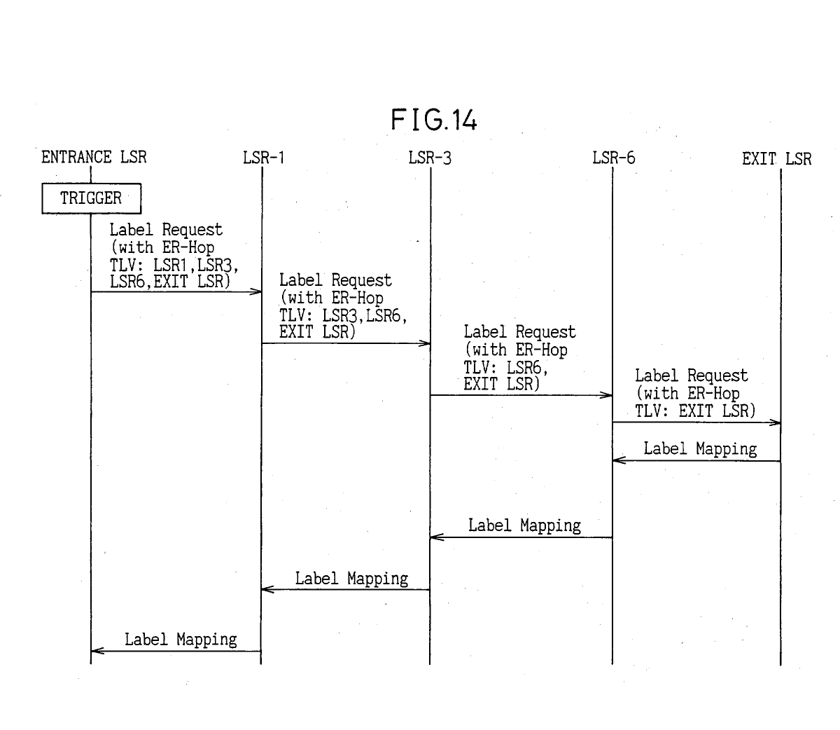

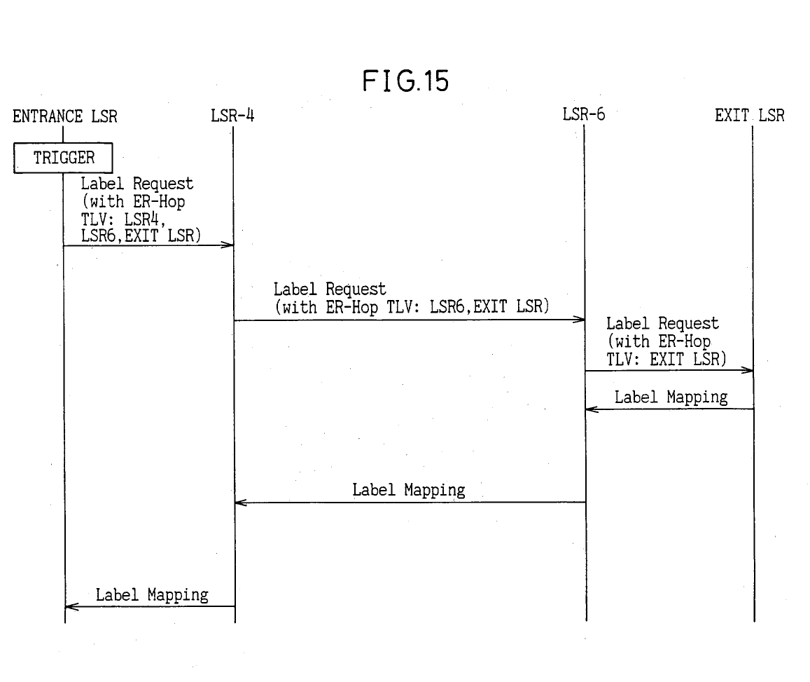

Examples of the sequences for constructing the path protection and link protection described above will be explained later by referring to FIG. 14 and FIG. 15. Before this, however, a description will be made of the background of the related art in order to facilitate understanding of these sequences.

At the present time, the MPLS-WG of the IETF is working to standardize a constraint-based route-label distribution protocol (CR-LDP) and resource reservation protocol-traffic engineering (RSVP-TE) for signaling of the MPLS-TE and both an extended CR-LDP and extended RSVP-TE for signaling of the GMPLS.

[A] The CR-LDP and RSVP-TE have the following main functions (1) to (5):

(1) Specification of Explicit Route

The protocol explicitly specifies a list of the repeating apparatuses (node or group of nodes) along the constraint-based route to set the LSP in the signaling message.

(2) Specification of Traffic Parameters

The protocol specifies the peak data rate (PDR), peak burst size (PBS), committed data rate (CDR), committed burst size (CBS), excess burst size (EBS), and other traffic parameters to set the LSP in the signaling message.

(3) Automatic Optimization (Route Pinning)

The protocol automatically reoptimizes the LSP when a more optimal route is formed concerning part of the set LSP due to a change of the topology and a change of the state of use of the resources.

(4) Preemption Control

When a route having sufficient resources could not be found when setting the LSP, the protocol reroutes to a new path so as to reallocate the resources of an already existing path (path preemption). Note that, as the parameters for this, a setup priority, holding priority, etc. are defined.

(5) Resource Class (Color)

Network resources can be classified by various methods by a network operator. This is referred to as the “resource class (color)”. When setting the LSP, the resource class (color) is used to specify this and thereby explicitly include or exclude certain classified groups (resources).

[B] The extended CR-LDP and the extended RSVP-TE for the above GMPLS have the following seven functions (1) to (7):

(1) Support of plurality of types of switching, for example, switching of the TDM, λ, and fiber (port)

(2) Acceptance of different types of payloads of LSP such as SONET, SDH, and 1 or 10 Gbit Ethernet

(3) Support of label suggested by upstream node (suggested label)

(4) Introduction of concept of restricting range of labels selected by downstream nodes

(5) Support for establishment of two-way LSP

(6) Support for communication of particular label used at particular interface

(7) Quick notification of faults

[C] The methods for protection (restoration) of an LSP may be roughly classified into the following two methods (1) and (2). These correspond to FIG. 12 and FIG. 13 explained above.

(1) Path protection (restoration) (FIG. 12) consisting of setting a secondary path Ps passing through a route passing through nodes or links completely different from those of the route over which the primary path Pp was set.

(2) Link path protection (restoration) (FIG. 13) consisting of setting a secondary path Ps where only certain nodes or links pass the route different from the route over which the primary path Pp was set.

Here, refer to FIG. 14 and FIG. 15. FIG. 14 is a view of an example of a sequence for setting path protection (FIG. 12), and FIG. 15 is a view of an example of the sequence for setting link protection (FIG. 13).

Here, the example of the sequence based on the signaling currently being considered, that is, signaling using the explicit route specifying function of the MPLS-TE, will be shown.

For setting protection, two methods may be considered: setting protection by the CR-LDP and setting protection by the RSVP-TE. The two are the same in concept, but here the case of setting protection by the CR-LDP will be illustrated.

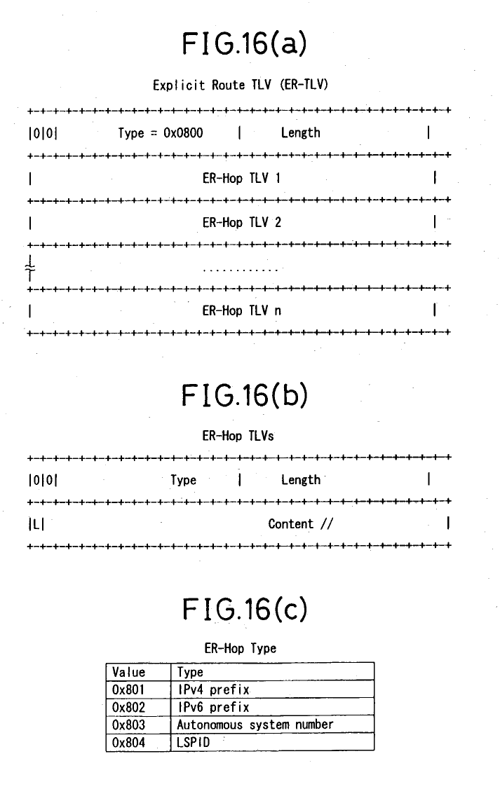

First, referring to FIG. 14, the top of the figure shows the group of LSRs determined by the procedure mentioned later, that is, LSR-1, LSR-3, and LSR-6, and the originally determined entrance LSR and exit LSR (refer to the route of Ps of FIG. 12). The entrance LSR triggers the successive transfer of a label request through the LSRs to reach the exit LSR. Then, using the exit LSR as a starting point, label mapping is successively transferred through LSRs. Below, this will be explained sequentially.

<1> Assume that the entrance LSR (21) learns the topology of the network (20) by various methods such as reference to the configuration, settings from the server, and acquisition by protocol such as the open shortest path first (OSPF) and boarder gateway protocol (BGP).

<2> The entrance LSR learns that the primary path (LSP) Pp is set through the entrance LSR, LSR-4, LSR-7 and the exit LSR by various methods, for example reference to the .configuration, settings from the server, and acquisition by protocol such as a path vector of the LDP.

<3> The entrance LSR learns by computation from the topology information of the network (20) and the information of the repeating nodes of the-primary path (LSP) Pp that the route passing through the LSR-1, LSR-3, and LSR-6 and the route passing through the LSR-2, LSR-5, and LSR-8 exist as secondary paths (LSP) for path protection and further determines the former route passing through LSR-1, LSR-3, and LSR-6 as the secondary path (LSP) by a certain policy.

<4> The entrance LSR sends out a message referred to as a “label request” including information specifying the ER-TLV (LSR1, LSR3, LSR6, exit LSR) to the LSR-1 based on this determination. “ER-TLV” means “explicit route-TLV”. TLV means “Type, Length, and Value” as shown in, e.g., FIGS. 16(a) to 16(c) etc.

<5> The LSR-1 receiving the label request evaluates the ER-TLV (LSR1, LSR3, LSR6, exit LSR) in the received label request, deletes the head object of the ER-TLV (that is, LSR1), and learns that it is to relay the data to the LSR-3. Then, it sends out a label request including information specifying the ER-TLV (LSR3, LSR6, exit LSR) for the LSR-3.

<6> Similarly, the LSR-3 receiving the label request evaluates the ER-TLV (LSR3, LSR6, exit LSR) in the received label request, deletes the head object of the ER-TLV (that is, LSR3), and learns that it is to relay the data to the LSR-6. Then, it sends out a label request including information specifying the ER-TLV (LSR 6, exit LSR) for the LSR-6.

<7> Further, the LSR-6 receiving the label request evaluates the ER-TLV (LSR6, exit LSR) in the received label request, deletes the head object of the ER-TLV (that is, LSR6), and learns that it is to relay the data to the exit LSR. Then, it sends out a label request including information specifying the ER-TLV (exit LSR) for the exit LSR.

<8> Finally, the exit LSR evaluates the ER-TLV (exit LSR) in the received label request, deletes the head object of the ER-TLV (that is, exit LSR), learns that the exit LSR itself is the end of the LSP, then returns a message referred to as “label mapping” to the LSR-6.

<9> Next, the Label Mapping is returned backward over the route LSR6→LSR-3→LSR-1→entrance LSR, whereupon the secondary path (LSP) is established.

Note that the functions of <1> to <3> may be installed in the LSR (21) itself or may be installed outside of the LSR (21).

Next, the sequence for setting link protection will be explained referring to FIG. 15. Note that this is basically the same as the explanation of the above <1>, <2>, <3>, . . . A summary thereof will be shown below.

<1> Assume that the entrance LSR (21) learns the topology of the network (20) by various methods such as reference to the configuration, settings from the server, and acquisition by OSPF, BGP, and other protocol.

<2> The entrance LSR learns that the primary path (LSP) is set to pass through the entrance LSR, LSR-4, LSR-7, and exit LSR by various methods such as reference to the configuration, settings from the server, and acquisition by the LDP path vector and other protocol.

<3> The entrance LSR learns by computation that a route passing through LSR-4 and LSR-6, a route passing, through LSR-4 and LSR-8, a route passing through LSR-4, LSR-3, and LSR-6, a route passing through LSR-2, LSR-5, and LSR-8, and so on exist as secondary paths (LSP) for link protection between the LSR-4 and LSR-7 from the topology information of the network (20) and the information of the repeating nodes of the primary path (LSP) and determines the route passing through the LSR-4 and LSR-6 as the secondary path (LSP) by a certain policy.

<4> The entrance LSR sends out to the LSR-4 a label request specifying the ER-TLV (LSR4, LSR6, exit LSR) based on the determination.

<5> The LSR-4 receiving the label request evaluates the ER-TLV (LSR4, LSR6, exit LSR) in the received label request, deletes the header object of the ER-TLV, and learns that it is to relay the data to the LSR-6. Then, it sends out a label request specifying the ER-TLV (LSR6, exit LSR) to the LSR-6.

<6> Similarly, the LSR-6 receiving the label request evaluates the ER-TLV (LSR6, exit LSR) in the received label request, deletes the header object of the ER-TLV, and learns that it is to relay the data to the exit LSR. Then, it sends out a label request specifying the ER-TLV (exit LSR) to the exit LSR.

<7> Finally, the exit LSR evaluates the ER-TLV (exit LSR) in the received label request, deletes the header object of the ER-TLV, learns that this exit LSR itself is the end of the LSP, then returns a message referred to as “label mapping” to the LSR-6.

<8> Next, the label mapping is returned back along the route LSR6→LSR-4→entrance LSR, whereby the secondary path (LSP) is established.

Note that the functions of <1> to <3> may be installed in the LSR (21) itself or may installed outside of the LSR (21).

The example of the sequence using the explicit route specifying function in the signaling of MPLS-TE explained referring to FIG. 14 and FIG. 15 is the most general example. Note, other than this, even if using the automatic optimization function and resource class, protection (restoration) can be realized even under certain limited conditions. However, this is not the general practice, so the explanation will be omitted here.

The keyword in the above explanation was the “ER-TLV”. For example, step <4> explained with reference to FIG. 14 was “the entrance LSR sends out a label request including information specifying the ER-TLV (LSR1, LSR3, LSR6, exit LSR) to the LSR-1 based on the determination at step <3>”.

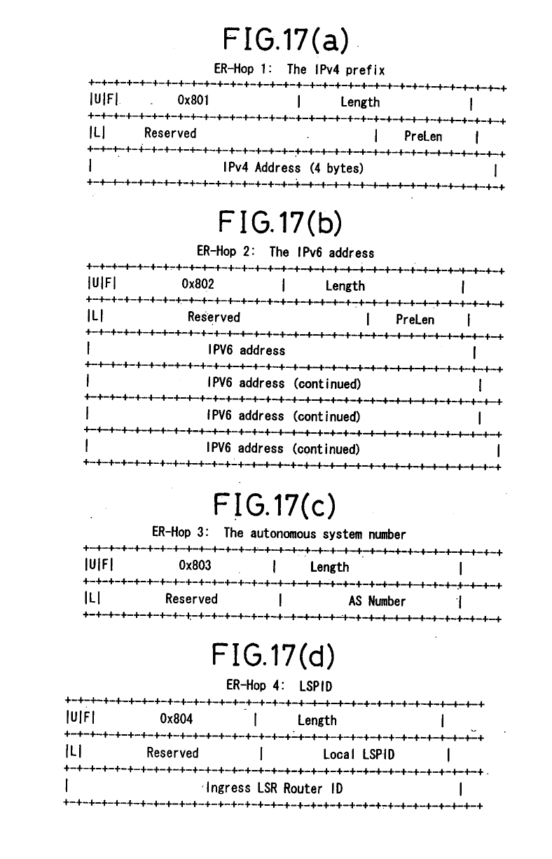

FIGS. 16(a), 16(b), and 16(c) are views showing part of the ER-TLV data format (part 1), while FIGS. 17(a), 17(b), 17(c), and 17(d) are views showing another part of the ER-TLV data format (part 2).

Note that the data formats shown here are well known.

In FIGS. 16(a) to 16(c), the ER-TLV is comprised by one or more explicit route LSP hop TLVs (ER Hop TLVS) and specifies a path for which the LSP must be established. Note that the values defined at present are shown in FIG. 16(c).

If supplementing the explanation for FIGS. 17(a) to 17(d), in FIG. 17(a):

L bit: A bit set for showing “loose hop” and cleared for showing “strict hop”

PreLen: Prefix length (1 to 32)

IPv4 Address: 4 byte field indicating IPv4 address

In FIG. 17(b),

L bit: A bit set for showing “loose hop” and cleared for showing “strict hop”

PreLen: Prefix length (1 to 128)

IPv6 Address: Unicast host address of 128 bits

In FIG. 17(c),

L bit: A bit set for showing “loose hop” and cleared for showing “strict hop”

AS Number: Autonomous system number

In FIG. 17(d),

L bit: A bit set for showing “loose hop” and cleared for showing “strict hop”

Local LSPID: 2-byte field showing unique LSPID (identification) for the reference at the entrance LSR thereof

Ingress LSR Router ID: 4-byte field indicating entrance LSR ID. Note that “loose” and “strict” will be explained later.

As shown in FIGS. 16(a) to 16(c) and FIGS. 17(a) to 17(d), the specification of the explicit route using the ER-TLV explicitly specifies the path over which the LSP is established. Specification of the following <1> and <2> is possible:

<1> The IPv4 prefix, IPv6 prefix, autonomous system number, or LSPID is specified strictly. Here, “strictly” means that there must not be a node of any network other than the networks specified by the current ER-Hop TLV and the immediately previous ER-Hop TLV between these two ER-Hop TLVs.

<2> The IPv4 prefix, IPv6 prefix, autonomous system number, or LSPID is specified loosely. Here, “loosely” means that there can be a node of any network other than the networks specified by the current ER-Hop TLV and the immediately previous ER-Hop TLV between these two ER-Hop TLVS.

As explained above, it is possible to explicitly indicate a route with a variety of granulariities by the IPv4 prefix, IPv6 prefix, autonomous system, or LSPID. By specifying “strict” or “loose”, the networks to be passed through can be limited or any network can be passed through. Note that the parts to be passed through must always be explicitly specified.

Accordingly, as already explained, when setting the LSP etc. for protection (restoration) by the explicit route specifying function, both when setting a path excluding all of repeating nodes (21) of the primary path and when setting a path excluding just particular nodes or links of the primary path, it is necessary to explicitly specify the nodes to be passed through.

Accordingly, as described in the explanations of FIG. 14 and FIG. 15, the following functions become essential:

1) acquisition of the topology of the network (20)

2) acquisition of information of LSRs through which the primary LSP passes

3) computation of the route of the link protection secondary path (LSP) by the topology information of the network (20) and the, information of the repeating nodes on the primary path. (LSP)

4) installation of a route determination policy for dealing with cases where there are a plurality of routes in the computation results and determination of a route using the policy

Note that installation in the LSR is not essential.

Here, for example, in the example of FIG. 14, any route can be passed through if the LSR-4 and LSR-7 are excluded. Therefore, by just notifying information indicating this by the signaling and leaving the determination of the NEXT Hop to each LSR, it becomes unnecessary to install the functions of the above 3) and 4).

Also, in the example of FIG. 15, any route can be passed through so far as the link between the LSR-4 and LSR-7 is excluded. Therefore, by just notifying information indicating this by the signaling and leaving the determination of the NEXT Hop to each LSR, it becomes unnecessary to install the functions of the above 3) and 4).

In this way, in the related art, even when desiring to exclude only a certain node or interface (21) or only a group of nodes or a group of interfaces (21), it was necessary to install the above functions 1) to 4) in the entrance LSR (or server) and explicitly determine the route.

This was the background behind the conception of the routing apparatus according to the present invention (refer to FIG. 1) and the routing method according to the present invention (refer to FIG. 2).

According to this routing apparatus or routing method, it becomes possible to realize various constraint-based routing or explicit routing services, particularly protection (restoration) services for various levels, for constraint-based routing/explicit routing in an Intranet, Internet backbone, optical network, transport network, etc. using the MPLS/GMPLS.

The present invention will be explained in further detail below. First, an explanation will be given of the mode of operation of the present invention, then the TLV data format required for the mode of operation, a concrete example of the routing apparatus 10, an example of the sequence of the signaling message in the network 20, and finally an embodiment of the route selection algorithm for working the present invention.

[A] Mode of Operation

Note that, in the following explanation, the repeating apparatus 21 will also be further concretely referred to as a “node or interface” or “group of nodes or group of interfaces”. Also, it will be also simply be referred to as a “node” or “interface”.

(1) Setting LSP Excluding Particular Node or Interface or Excluding Particular Group of Nodes or Group of Interfaces

When setting the LSP, the point of the present invention is to set the LSP not by explicitly specifying as the constraint condition a particular node or interface or a particular group of nodes or group of interfaces through which the LSP should pass (related art), but by explicitly specifying a particular node or interface or a particular group of nodes or group of interfaces through which the LSP must not pass.

For example, referring to FIG. 12, when establishing a secondary path (LSP) PS for path protection for the primary path (LSP) Pp of “entrance LSR →LSR-4→LSR-7→exit LSR”, the method of the present invention is to set the LSP not by explicitly specifying the entrance LSR, LSR-1, LSR-3, LSR-7, and the exit LSR (related art), but by explicitly specifying that the two nodes LSR-4 and LSR-7 must be excluded.

Also, referring to FIG. 13, when establishing a secondary path (LSP) for link protection between LSR-4 and LSR-7 for the primary path (LSP) Pp of “entrance LSR →LSR-4→LSR-7→exit LSR”, the method of the present invention is to set the LSP not by explicitly specifying the route of the “entrance LSR→LSR-4→LSR-6→exit LSR” (related art), but by explicitly specifying that the link between LSR-4 and LSR-7 must be excluded.

Namely, according to the routing apparatus 10 (FIG. 1) of the present invention, the path setting operation is decentralized to the repeating apparatuses 21, so each of the plurality of repeating apparatuses 21 involved in the label switching can autonomously set a path except for having to obey the above mentioned constraint condition of the excluded parts.

Explaining this with reference to the already explained FIG. 2, at the second step S12, this operation is decentralized to the individual repeating apparatuses 21 and autonomously executed.

Explaining this more concretely, except for the constraint condition of the exclusion of a particular node or interface or a particular group of nodes or group of interfaces, it becomes possible to decentralize the path setting operation to the individual nodes (21) and autonomously set the LSP at every node (21). Referring to FIG. 12, each of the entrance LSR, LSR-1, LSR-3, and LSR-7 autonomously determines the NEXT Hop while considering the constraint condition of exclusion of the two nodes LSR-4 and LSR-7. Also, referring to FIG. 13, each of the entrance LSR, LSR-4, and LSR-6 autonomously determines the NEXT Hop while considering the constraint condition of exclusion of the link between LSR-4 and LSR-7.

A concrete example of this determination will be explained in the following (2).

(2) Computation and Determination of Particular Node or Interface or Particular Group of Nodes or Group of Interfaces to Be Excluded Based on Information on the Service to Be Realized, Pass Node Information of the LSP, Topology Information of the Network, Fault Information and Route Determination Policy

The determination of a particular node or interface or a particular group of nodes or group of interfaces to be excluded requires various types of information depending on the service to be realized. For example, information on the service to be realized, pass node information of the LSP, topology information of the network, fault information, route determination policy, etc. can be mentioned.

By determining a particular node or interface or a particular group of nodes or group of interfaces to be excluded based on this information, the above (1) can be realized.

Referring to FIG. 1, the part exclusion specifying means 12 determines the excluded parts based on at least one information among the service information concerning the service to be realized in the network 20, pass information concerning the repeating apparatuses 21 passed through on the path to be label switched, topology information concerning the configuration of the network, fault information concerning any fault occurring in the network, and policy information determining which route to be set when there are two or more routes which can be set.

Note that the services indicated by the above service information can include a protection service for providing a secondary path Ps as a backup of the primary path Pp or a decentralizing service for providing an auxiliary path when the traffic abruptly increases.

Here, for example, consider the case of determining a particular node or interface or a particular group of nodes or group of interfaces to be excluded under the following conditions in the example of FIG. 12:

(i) The service to be realized is restoration.

(ii) The route of the LSP (primary path) is the entrance LSR, LSR-4, LSR-7, and exit LSR.

(iii) The topology information is as shown in FIG. 12. Note that, in the case of this service, the topology information is used for only the determination of NEXT Hop.

(iv) The fault information is the information at the time of a fault notification of the LSP from the LSR-4 or LSR-7 or the exit LSR or a time when an LSP detects a fault in itself.

(v) The route determination policy is a policy at the path level, that is, the LSRs passing through the primary path (LSP) are all excluded.

In this case, first, the entrance LSR (FIG. 12) starts the restoration service (i) triggered by the detection of a fault of the LSP (iv). At this time, since the route passing through the primary path (LSP) is as described in (ii) and the policy is restoration at the path level (v), LSR-4 and LSR-7 are determined as the nodes to be excluded on the LSP to be newly set. Further, NEXT Hop (LSR-1) is determined based on the node exclusion condition and the topology information (iii) of the network.

The method of the explicit specification of this exclusion condition will be explained in the following (3).

(3) Explicit Specification of Particular Node or Interface or Particular Group of Nodes or Group of Interfaces to Be Excluded

Referring to FIG. 1, the part exclusion specifying means 12 uses the signaling message and specifies one or more parts not to be passed through in the signaling message.

In this case, the signaling message is an MPLS-TE signaling message or a GMPLS signaling message.

Further, for explicitly specifying the exclusion parts, the part exclusion specifying means 12

(i) mixes the explicit route exclusion data into the explicit route specifying data set (for example ER-TLV) composing the message (mixed type) or

(ii) generates an explicit route exclusion data set (for example the EX-TLV mentioned later) including the explicit route exclusion data independently from the explicit route specifying data set (for example ER-TLV) and forms the message from the explicit route specifying data set and explicit route exclusion data set (independent type).

This will be explained further concretely below.

The particular node or interface or the particular group of nodes or group of interfaces to be excluded determined in the above (2) are explicitly specified by using the MPLS-TE signaling and GMPLS signaling message. In more detail, each of the CR-LDP or RSVP-TE is extended to realize this.

For example, in the case of the CR-LDP, a TLV indicating the exclusion of the particular node or interface is added to the ER-Hop TLV of the ER-TLV, and one or more related TLVs are set in the ER-TLV (above mixed type).

Alternatively, independent from the ER-TLV, a TLV indicating the exclusion of a particular node or interface and a TLV forming the TLV in the list format are defined (above independent type).

Due to this, it becomes possible for the routing apparatus 10 to autonomously and decentrally realize the setting of the LSP in the above (1) while considering the exclusion of a particular node or interface or particular group of nodes or group of interfaces.

After setting the LSP, the LSP is finally established. This will be explained by the following (4).

(4) Routing Based on Information of Particular Node or Interface or Particular Group of Nodes or Group of Interfaces to Be Excluded and Topology Information of Network

By this routing, the NEXT Hop is determined at each node (21), then the LSP is established based on the result of the determination.

First, the entrance LSR (21) and the repeating LSRs (21) consider the information of the particular node or interface or particular group of nodes or group of interfaces to be excluded in addition to the determination of the NEXT Hop, i.e., the routing by the topology information of the network 20 so as to perform routing (determination of the NEXT Hop) and determine the router to relay the label request to and transmits this to that destination. As a result, an LSP excluding particular node or interface or particular group of nodes or group of interfaces is established.

Thus, it becomes possible to autonomously and decentrally realize the setting of the LSP in the above (1) while considering the exclusion of a particular node or interface or particular group of nodes or group of interfaces.

[B] TLV Data Format

The various types of TLV mentioned above for realizing the mode of operation of [A] will be concretely explained below referring to the drawings.

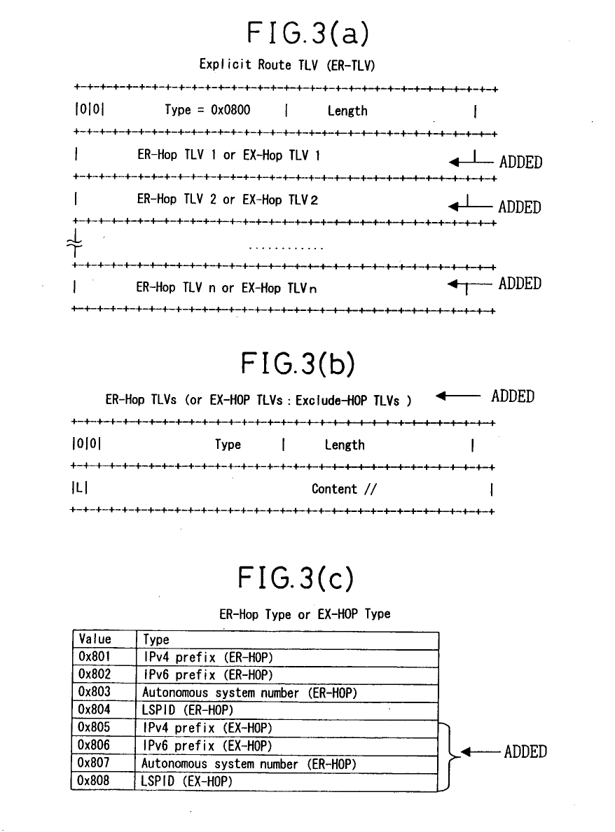

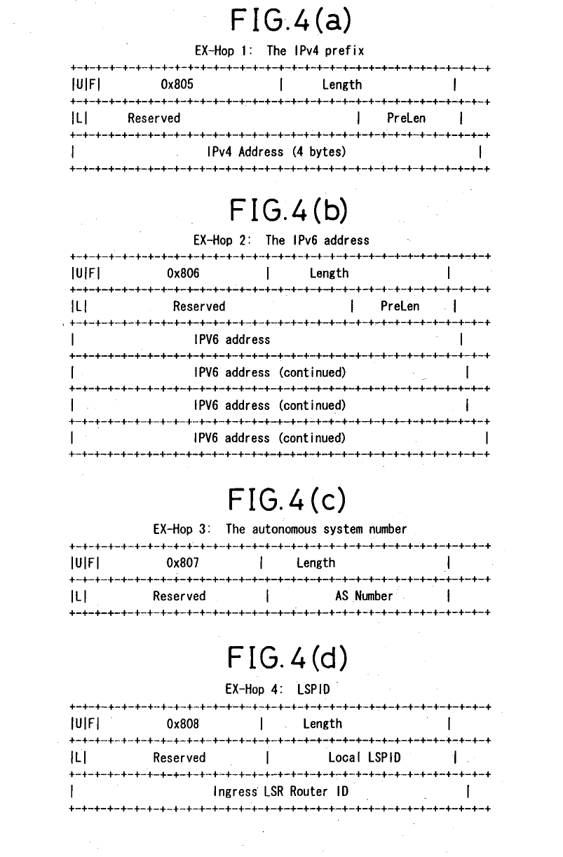

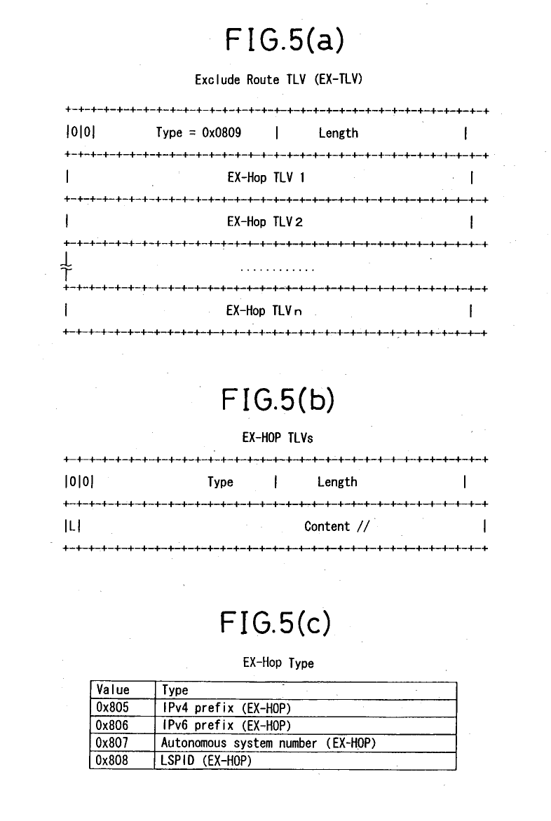

FIGS. 3(a), 3(b), and 3(c) are views of part of an example of the ER-TLV data format (mixed type) based on the present invention; while FIGS. 4(a), 4(b), 4(c), and 4(d) are views of another part of the example of the ER-TLV data format (mixed type) based on the present invention. Note that the “mixed type” and “independent type” were defined above. Also, FIGS. 5(a), 5(b), and 5(c) are views of an example of the EX-TLV data format (independent type) based on the present invention.

FIGS. 3(a) to 3(c), FIGS. 4(a) to 4(d), and FIGS. 5(a) to 5(c) should be viewed in the same way as FIGS. 16(a) to 16(c) and FIGS. 17(a) to 17(d). That is, FIGS. 3(a) to 3(c) show an example of the addition of the EX-Hop to the ER-TLV and show that the EX-Hop TLV is configured together with the ER-Hop TLV, FIGS. 4(a) to 4(d) show examples of the formats of the newly defined EX-Hop1, EX-Hop2, EX-Hop3, and EX-Hop4, and FIGS. 5(a) to 5(c) show an example of composing a signaling message explicitly specifying the excluded route by extension of the CR-LDP. The EX-TLV is comprised by one or more Exclude Route LSP Hop TLVs (EX-Hop. TLVS) and specifies the path for which the LSP is established and which must be excluded.

In FIGS. 4(a) to 4(d), this TLV is comprised by four types of TLVs of the IPv4 prefix, IPv6 prefix, autonomous system number, and LSPID similar to the ER-Hop TLV. The configuration of each is identical to that of the above ER-Hop TLV except the L bit is a Strict Hop prefix.

Further supplementing the explanation, in FIG. 3(a), the ER-TLV is comprised by one or more Explicit Route LSP Hop TLVs (ER-Hop TLVS) and specifies the path for which the LSP is established. Also, in FIGS. 3(a) and 3(c), the portions described as “ADDED” are data regions introduced by the present invention.

Further supplementing the explanation for FIGS. 4(a) to 4(d), in the EX-Hop1 of FIG. 4(a),

L bit: Strict Hop prefix,

PreLen: Prefix length (1 to 32), and

IPv4 Address: 4-byte field indicating IPv4 address,

in the EX-Hop2 of FIG. 4(b),

L bit: Strict Hop prefix,

PreLen: Prefix length (1 to 128), and

IPv6 Address: Unicast host address of 128 bits,

in the EX-Hop3 of FIG. 4(c),

L bit: Strict Hop prefix and

AS number: Autonomous system number, and

in the EX-Hop4 of FIG. 4(d),

L bit: Strict Hop prefix,

Local LSPID: 2-byte field indicating unique LSPID for reference at the entrance LSR thereof, and

Ingress LSR Router ID: 4-byte field indicating entrance LSR ID.

The repeating apparatus 21 operating by using the above mentioned TLV will be explained next.

[C] Concrete Example of Routing Apparatus 10

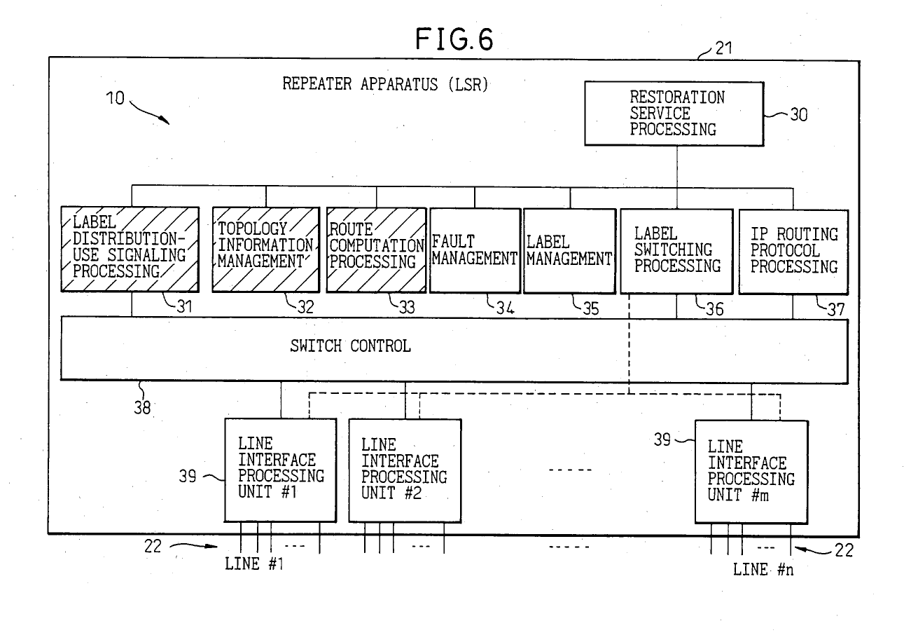

FIG. 6 is a view of the concrete configuration of the repeating apparatus 21.

The routing apparatus 10 forming the core of the present invention is mainly realized by the hatched components in the figure. The routing apparatus 10 can be formed inside each repeating apparatus 21 or can be a single apparatus shared by a plurality of repeating apparatuses 21. In the latter case, the routing apparatus 10 is provided anywhere inside the network 20 and connected with the repeating apparatuses 21 by individual transmission lines.

As shown in the figure, the repeating apparatus 21 is configured by a restoration service processing unit 30, label distribution-use signaling processing unit 31, topology information management unit 32, route computation processing unit 33, fault management unit 34, label management unit 35, label switching processing unit 36, IP routing protocol processing unit 37, switch control unit 38, and line interface processing units (#1 to #m) 39.

Below, the functions of each component will be explained.

The restoration service processing unit 30 oversees the restoration service relating to the label switching. It is activated by an external command (for example, for the construction of path protection) sent from, e.g., the network operator via a personal computer.

When the repeating apparatus 21 of the figure operates as the entrance LSR, it sets the initial LSP and monitors for faults in the related LSP together with the fault management unit 34. Here, when detecting a fault in the related LSP (either by the LSR (21) itself or by fault notification from another LSR (21)), it sets a restoration-use LSP for that LSP. When setting this LSP, it refers to the topology information management unit 32, decides the node to be excluded, and requests the label distribution-use signaling processing unit 31 to set the related LSP while specifying the node to be excluded and the exit LSR.

When the repeating apparatus 21 of the figure operates as a repeating LSR or the exit LSR, it monitors for faults in the LSP together with the fault management unit 34. When detecting a fault, it notifies the fault of the LSP to the entrance LSR.

The label management unit 35 manages labels based on the operating conditions given from the restoration service processing unit 30. It assigns labels and releases labels according to requests from the label distribution-use signaling processing unit 31.

The label distribution-use signaling processing unit 31 assigns and distributes labels corresponding to the forwarding equivalence class (FEC) with the adjacent LSR by interaction with the label distribution-use signaling processing unit inside the LSR (not illustrated) adjacent to that LSR (LSR of FIG. 6) and the label management unit 35 of the apparatus itself (apparatus of FIG. 6) according to a request from the restoration service processing unit 30. By this, it sets the LSP and notifies the set LSP to the label switching processing unit 36 and the label management unit 35.

The label switching processing unit 36 acquires the necessary information from the label management unit 35 by the notification from the label distribution-use signaling processing unit 31, notifies the switching information to the switch control unit 38, and performs label switching by interaction with the line interface processing unit 39 and the switch control unit 38.

The switch control unit 38 controls the switch (label switch) according to a request from the label switching processing unit 36.

Each line interface processing unit (#1 to #m) 39 realizes label switching by the interaction with the label switching processing unit 36 and the switch control unit 38 and transfers messages from the restoration service processing unit 30.and the.label distribution-use signaling processing unit 31 or to the processing unit 31 via the switch control unit 38.

The IP routing protocol processing unit 37 prepares an IP routing table by interaction with other routers (LSRS) according to the IP routing protocol or according to the configuration of the network and gives the information triggering the setting or release of the FEC to the restoration service processing unit 30, label switching processing unit 36, and label distribution-use signaling processing unit 31.

The topology information management unit 32 manages the topology information of the network via the IP routing protocol processing unit 37 and the label distribution-use signaling processing unit 31.

The fault management unit 34 monitors for faults in the LSP, links, etc. and notifies the occurrence of any fault detected to the restoration service processing unit 30.

The route computation processing unit 33 computes the route based on the information from the topology information management unit 32 and the route selection condition (policy) from the restoration service processing unit 30 and determines the destination of the transmission of the signaling message.

The sequence of transfer of this signaling message in the network 20 will be explained in [D] below.

[D] Sequence of Transfer of Signaling Message Inside Network 20

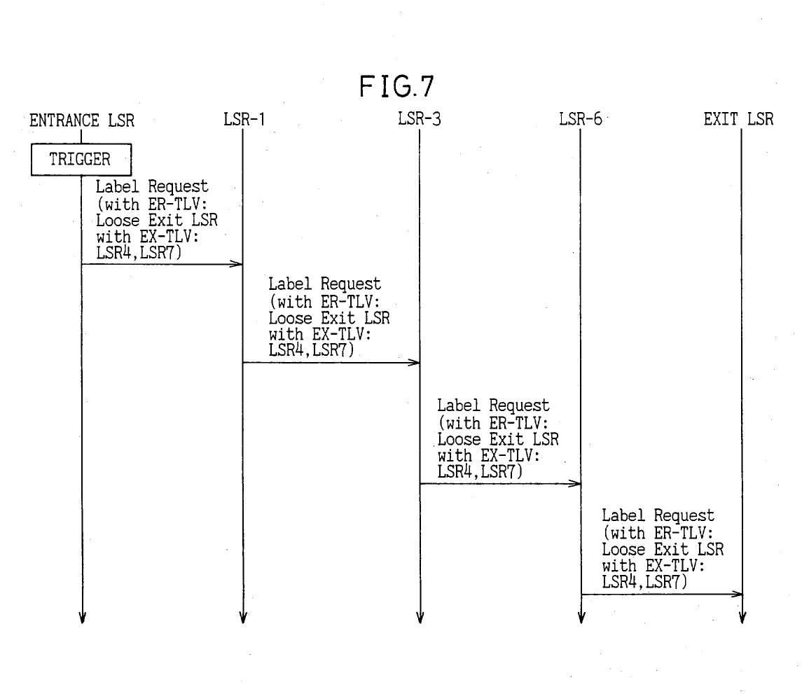

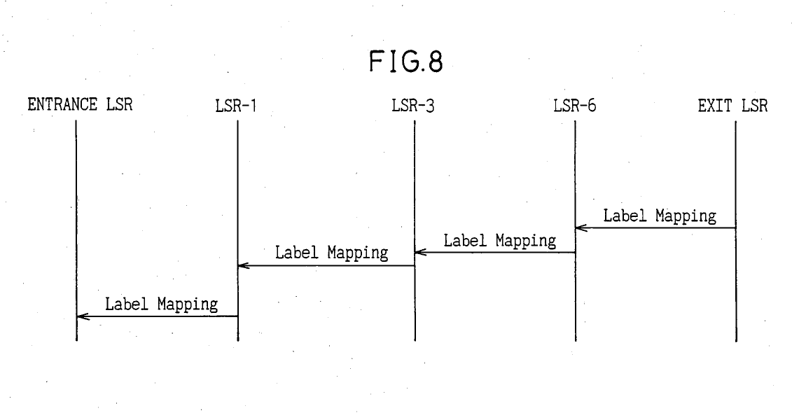

FIG. 7 and FIG. 8 are views of an example of the sequence for setting path protection based on the present invention. The figures correspond to FIG. 14 showing the sequence of the related art.

Note that the part of the sequence of FIG. 7 shows the sequence where the EX-Hop TLV is set in the EX-TLV (refer to FIG. 5) as an example. It is a message transfer sequence where the route to be excluded is explicitly specified by the extension of the CR-LDP. Below, the operation will be explained step by step.

<1> The entrance LSR determines the route to be explicitly excluded. This is determined by the route computation processing unit 33 (FIG. 6) by a request from the service processing unit. After this, the exit LSR is set in the ER-TLV (Loose is specified), the LSR-4 and LSR-7 are set in the EX-TLV, and the label request message is sent out to the LSR-1.

<2> The LSR-1 receiving the label request message evaluates the ER-TLV and EX-TLV in the received message and determines the LSR-3 as where the label request message should be relayed. This is specifically determined by the route computation processing unit 33 of FIG. 6. The label request message is then sent to the LSR-3.

<3> The LSR-3 receiving the label request message evaluates ER-TLV and EX-TLV in the received message and determines the LSR-6 as where the label request message should be relayed. This is specifically determined by the route computation processing unit 33 of FIG. 6. The label request message is then sent to the LSR-6.

<4> The LSR-6 receiving the label request message evaluates ER-TLV and EX-TLV in the received message and determines the exit LSR as where the label request message should be relayed. This is specifically determined by the route computation processing unit 33 of FIG. 6. The label request message is then sent to the exit LSR.

<5> The exit LSR receiving the label request message recognizes that it itself is the exit LSR by the ER-TLV in the received message. It specifically recognizes this by the route computation processing unit 33 and determines and sets the LSP (label) with the adjacent LSR. Further, it returns a label mapping message (FIG. 8) to the LSR-6.

<6> The LSR-6 receiving the label mapping message sets the LSP for the LSR-3 on the downstream side and determines and sets the LSP (label) with the adjacent LSR on the upstream side. Then, it returns a label mapping message to the LSR-3.

<7> The LSR-3 receiving the label mapping message sets the LSP for the LSR-1 on the downstream side and determines and sets the LSP (label) with the adjacent LSR on the upstream side. Then, it returns a label mapping message to the LSR-1.

<8> The LSR-1 receiving the label mapping message sets the LSP for the downstream side and determines and sets the LSP (label) with the adjacent LSR on the upstream side. Then, it returns a label mapping message to the entrance LSR.

<9> The entrance LSR receiving the label mapping message sets the LSP for the downstream side and terminates the sequence.

[E] Route Selection Algorithm in Routing Apparatus 10 of Present Invention

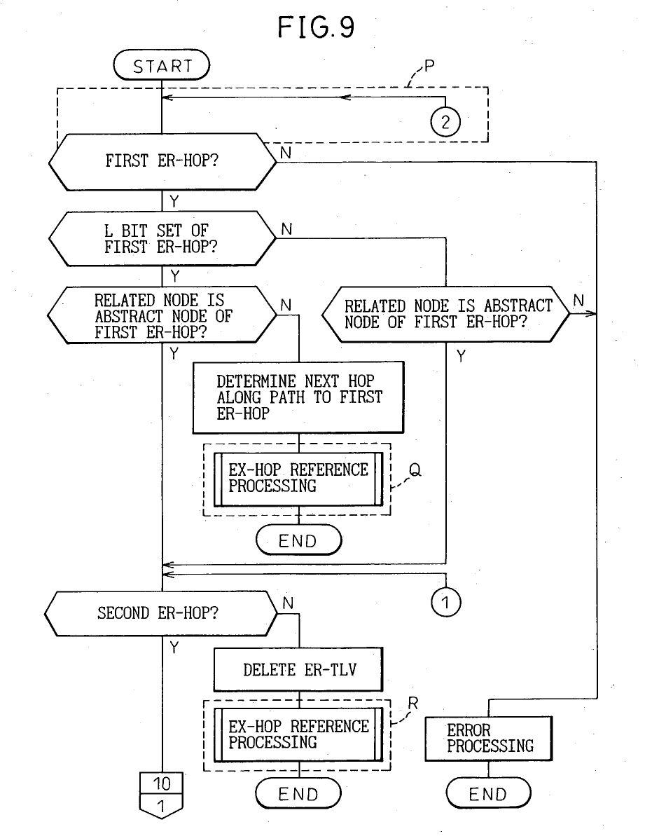

FIG. 9 to FIG. 11 are views of an example of the route selection algorithm applied to the routing apparatus 10 of the present invention. Note that the relationship of the figures is shown at the right bottom of FIG. 11.

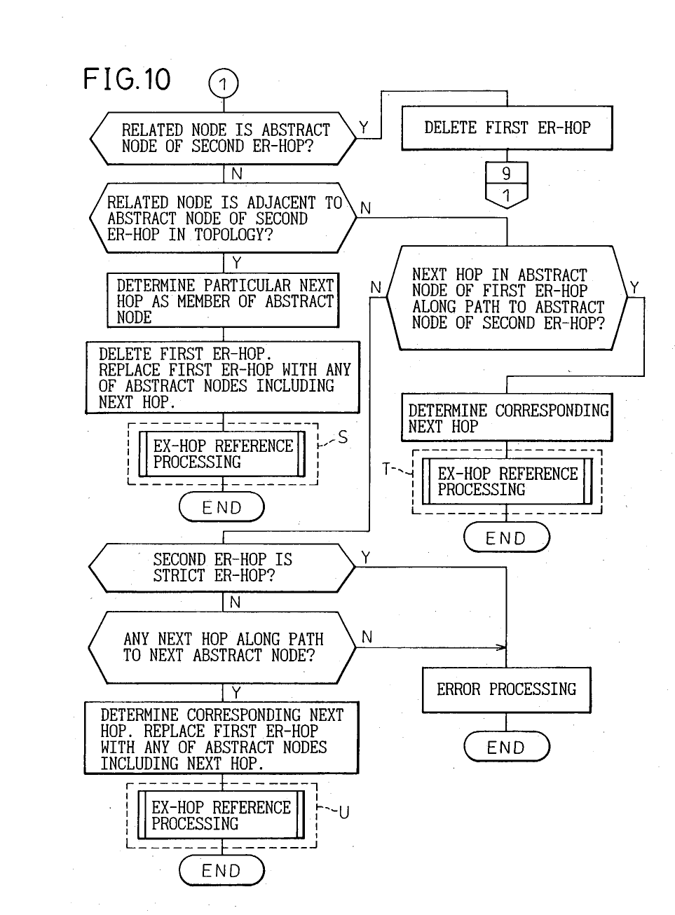

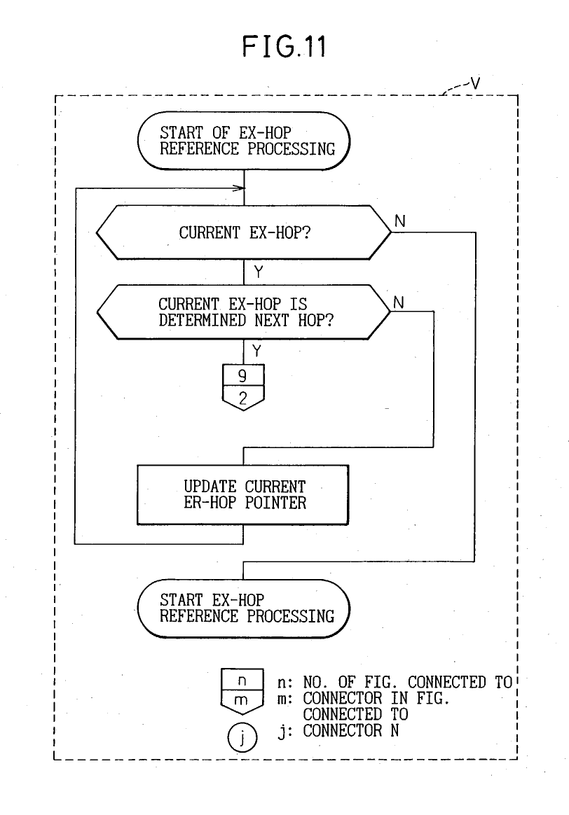

In FIG. 9 to FIG. 11, the processings (steps) of the portions surrounded by the broken line frames P, Q, R, S, T, U, and V are processings (steps) introduced according to the present invention. In FIG. 9 and FIG. 10, processings (steps) other than these processings (steps) are well known ones recommended by standards.

Accordingly, only the functions which particularly must be noted in the present invention will be explained.

As shown in FIG. 9 to FIG. 10, after executing the basic algorithm for selecting and determining the route by the ER-TLV, it is checked if the related NEXT Hop is specified by the EX-TLV. If it is not specified by the EX-TLV, this is finally decided as the NEXT Hop. On the other hand, when the related NEXT Hop is specified by the EX-TLV, the algorithm for selecting and determining the route by the ER-TLV is executed again. This operation is repeated until there are no longer any candidates of the NEXT Hop.

As explained above, according to the present invention, the following effects can be expected in an Intranet, Internet backbone, optical network, transport network, etc. using the MPLS/GMPLS:

(i) Constraint-based routing or explicit routing can be more flexibly and easily realized under various conditions.

(ii) Particularly, provision of a protection (restoration) function can be more flexibly and easily realized.

(iii) The effects of the above (i) and (ii) can be obtained without an accompanying increase of cost of the repeating apparatus.

While the invention has been described with reference to specific embodiments chosen for purpose of illustration, it should-be apparent that numerous modifications could be made thereto by those skilled in the art without departing from the basic concept and scope of the invention.

What is claimed is:

1. A routing apparatus in a network supporting label switching among a plurality of repeating apparatuses, comprising:
a path setting means for setting paths to be label switched inside said network and
a part exclusion specifying means for specifying to said path setting means one or more parts not to be passed through among said paths to be set.

2. A routing apparatus as set forth in claim 1, wherein said part is at least one of a part in which a repeating apparatus is located or a part in which a link spanning a plurality of repeating apparatuses is located.

3. A routing apparatus as set forth in claim 1, wherein said repeating apparatus is a node or an interface configuring said network.

4. A routing apparatus as set forth in claim 1, wherein each of a plurality of said repeating apparatuses involved in said label switching autonomously sets said path decentrally except for obeying a constraint condition of said exclusion parts.

5. A routing apparatus as set forth in claim 1, wherein said part exclusion specifying means determines said exclusion parts based on at least one information among service information concerning a service to be realized in said network, pass information concerning repeating apparatuses passed through on said path to be label switched, topology information concerning the configuration of said network, fault information concerning a fault occurring in said network, and policy information determining which route to be set when there are two or more routes which can be set.

6. A routing apparatus as set forth in claim 1, wherein the service indicated by said service information includes a protection service for providing a secondary path as a backup of a primary path or a decentralizing service for providing an auxiliary path when traffic abruptly increases.

7. A routing apparatus as set forth in claim 1, wherein said part exclusion specifying means uses a signaling message and specifies said one or more parts not to be passed through in the signaling message.

8. A routing apparatus as set forth in claim 7, wherein said signaling message is an MPLS-TE signaling message.

9. A routing apparatus as set forth in claim 7, wherein said signaling message is a GMPLS-TE signaling message.

10. A routing apparatus as set forth in claim 8, wherein explicit route exclusion data is mixed into an explicit route specifying data set composing said message.

11. A routing apparatus as set forth in claim 9, wherein explicit route exclusion data is mixed into an explicit route specifying data set composing said message.

12. A routing apparatus as set forth in claim 8, wherein the explicit route exclusion data set including the explicit route exclusion data is generated independently from the explicit route specifying data set, and said message is comprised by the explicit route specifying data set and the explicit route exclusion data set.

13. A routing apparatus as set forth in claim 9, wherein the explicit route exclusion data set including the explicit route exclusion data is generated independently from the explicit route specifying data set, and said message is comprised by the explicit route specifying data set and the explicit route exclusion data set.

14. A routing apparatus as set forth in claim 1, wherein said routing apparatus is formed inside said repeating apparatus.

15. A routing apparatus as set forth in claim 1, wherein said routing apparatus is a single apparatus shared by said plurality of repeating apparatuses.

16. A routing method for setting a path from an entrance repeating apparatus through at least one intermediate repeating apparatus to an exit repeating apparatus in a network supporting label switching among a plurality of repeating apparatuses, comprising:
a first step of specifying a repeating apparatus not to be passed through and/or a link spanning two or more repeating apparatuses not to be passed through among said paths to be set and
a second step for setting said path by explicitly excluding the specified repeating apparatus and/or link not to be passed through.

17. A routing method as set forth in claim 16, wherein said second step is autonomously executed decentrally by every repeating apparatus.
